(19) United States
(12) Patent Application Publication
(10) Pub. No.: US 2026/0299298 A1
(43) Pub. Date: Oct. 1, 2026

(54) OPTICAL ENGINE SYSTEM AND NEAR-EYE DISPLAY DEVICE

(71) Applicant: Ningbo Sunny Opotech Co., Ltd., Yuyao City (CN)

(72) Inventors: Haotian XU, Yuyao City (CN); Yuqi ZHANG, Yuyao City (CN); Bingyu LIU, Yuyao City (CN); Jiawei DU, Yuyao City (CN)

(73) Assignee: Ningbo Sunny Opotech Co., Ltd., Yuyao City (CN)

(21) Appl. No.: 19/413,771

(22) Filed: Dec. 9, 2025

(30) Foreign Application Priority Data
Mar. 27, 2025 (CN) 202510370949.9

(51) Int. Cl. G02B 27/01

(52) U.S. Cl. CPC G02B 27/0172

(57) ABSTRACT

An optical engine system and a near-eye display device are disclosed. The optical engine system includes an illumination assembly, a display chip, and a relay imaging assembly. The illumination assembly includes a light source and a folding prism having aspheric incident and exit surfaces and a planar reflective surface. The relay imaging assembly includes a polarizing beam splitter (PBS), a reflective element, and first and second correction lens groups. The first correction lens group is disposed between the PBS and the display chip and includes a fourth lens and a fifth lens cemented together. The second correction lens group is disposed on a light-exit side of the PBS and includes a first lens with positive optical power and a second lens with negative optical power. The reflective element has positive optical power. A focal length f3 of the reflective element and a focal length f of the optical engine system satisfy 0.6<f/f3<1.

### TECHNICAL FIELD

The present application relates to the field of near-eye display technology, and more particularly, to an optical engine system and a near-eye display device.

### BACKGROUND

With the rapid development of AR display technology, higher requirements are placed on the field of view (FOV), resolution, brightness, and structural compactness of display devices. AR display technology based on Liquid Crystal on Silicon (LCOS) has become the preferred solution for AR optical engine manufacturers at the current stage and demonstrates great development potential, owing to its advantages such as high resolution, high brightness, low cost, and full-color display. However, the FOV of existing LCoS optical engines is typically small, only around 20-40°, which, although meeting the needs of enterprise-level application scenarios, lacks immersiveness in consumer-level applications, affecting the user experience.

As optical waveguide technology based on silicon carbide materials matures, the FOV of diffractive waveguide plates can now achieve displays of over 70°. Meanwhile, the development of LCOS display technology has made it possible to achieve higher resolution within the same size display area, which enables AR displays with a large viewing angle, high resolution, and high immersiveness.

However, to match the waveguide, the aperture stop of an AR optical engine needs to be placed at the very front of the lens assembly. In this case, the aperture stop coincides with the exit pupil of the lens assembly, and the exit pupil diameter (EPD) is typically 2-4 mm. Since the F-number is directly proportional to the focal length f, with the EPD size remaining unchanged, this leads to a rapid decrease in the F-number of the lens assembly, and a smaller F-number requires the lens assembly to have higher resolution. Therefore, the demands for a large FOV, high resolution, and miniaturization pose challenges to the design of full-color AR optical engines.

### SUMMARY

An object of the present application is to achieve a large FOV and high resolution for a full-color optical engine system while maintaining a small size for the lens assembly.

Another object of the present application is to reduce aberrations generated in the optical engine system while achieving a large FOV for the full-color optical engine system.

Another object of the present application is to reduce chromatic aberrations generated in the optical engine system while achieving a large FOV for the full-color optical engine system.

To achieve the above objects, the technical solution of the present application is as follows: an optical engine system, comprising:
an illumination assembly, comprising a light source and a folding prism, wherein the light source is configured to provide illumination light, and the folding prism has an incident surface facing the light source, a reflective surface, and an exit surface facing a polarizing beam splitter, and is configured to deflect the illumination light;
a display chip, configured to modulate the illumination light into image light;
a relay imaging assembly, comprising the polarizing beam splitter, a first correction lens group, and a reflective element, wherein the display chip and the reflective element are disposed on opposite sides of the polarizing beam splitter, and the display chip and the folding prism are disposed on adjacent sides of the polarizing beam splitter, the first correction lens group is disposed between the polarizing beam splitter and the display chip, the first correction lens group comprises a fourth lens and a fifth lens that are cemented together, the fourth lens with positive optical power is disposed on a side close to the polarizing beam splitter, and the fifth lens with negative optical power is disposed on a side close to the display chip; the reflective element has positive optical power, and the focal length f₃ of the reflective element and the focal length f of the optical engine system satisfy: 0.6<f/f₃<1.

Preferably, the surface of the reflective element away from the polarizing beam splitter is an aspheric surface, wherein the inner side of the aspheric surface is coated with a reflective film, and the surface of the reflective element close to the polarizing beam splitter is a planar surface.

Preferably, the refractive index of the fourth lens is less than the refractive index of the fifth lens, and the Abbe number of the fourth lens is greater than the Abbe number of the fifth lens.

Preferably, both surfaces of the fourth lens are convex surfaces, the surface of the fifth lens away from the display chip is a concave surface, and the surface close to the display chip is a convex surface.

Preferably, the relay imaging assembly further comprises a second correction lens group disposed on the light-exit side of the polarizing beam splitter, wherein the second correction lens group comprises a first lens with positive optical power and a second lens with negative optical power, the first lens is disposed on a side away from the polarizing beam splitter, and the second lens is disposed on a side close to the polarizing beam splitter.

Preferably, the refractive index of the first lens is less than the refractive index of the second lens, and the Abbe number of the first lens is less than the Abbe number of the second lens.

Preferably, both surfaces of the first lens are convex surfaces, the surface of the second lens close to an exit end of the optical engine system is a concave surface, and the surface away from the exit end of the optical engine system is a planar surface.

Preferably, the first lens and the second lens are cemented together.

Preferably, the relay imaging assembly further comprises a first polarizer and a quarter-wave plate, wherein the first polarizer is disposed on the light-exit side of the polarizing beam splitter and between the second lens and the polarizing beam splitter; and the quarter-wave plate is disposed between the reflective element and the polarizing beam splitter.

Preferably, the illumination assembly further comprises a second polarizer, wherein the second polarizer is disposed between the exit surface of the folding prism and the polarizing beam splitter.

Preferably, the relay imaging assembly further comprises a first diffuser, wherein the first diffuser is disposed between the exit surface of the folding prism and the second polarizer.

Preferably, a near-eye display device comprises any one of the aforementioned optical engine systems and a waveguide device, wherein the optical engine system is disposed on the in-coupling side of the waveguide device and is configured to project the image light to the in-coupling port of the waveguide device.

Compared with the prior art, the beneficial effects of the present application are as follows: in the optical engine system according to the present application, the reflective element can bear the main optical power, achieving the short focal length required for a large angle of the optical engine system and ensuring a large field of view; meanwhile, by providing correction lens groups, aberrations and chromatic aberrations caused by increasing the field of view are corrected, thereby achieving a high-definition full-color AR optical engine; the combined use of the reflective element, the folding prism, and the correction lens groups can reduce the volume of the optical engine. In this way, a full-color AR optical engine with a large FOV, high resolution, and miniaturization can be achieved.

### BRIEF DESCRIPTION OF THE DRAWINGS

FIG. 1 is a schematic structural diagram of an optical engine system according to an embodiment of the present application;

FIG. 2 is a green light MTF graph of the optical engine system in Embodiment 1 of the present application;

FIG. 3 is a red light MTF graph of the optical engine system in Embodiment 1 of the present application;

FIG. 4 is a blue light MTF graph of the optical engine system in Embodiment 1 of the present application;

FIG. 5 is a lateral chromatic aberration graph of the optical engine system in Embodiment 1 of the present application;

FIG. 6 is an LCOS illuminance diagram of the optical engine system in Embodiment 1 of the present application;

FIG. 7 is a projected image intensity distribution diagram of the optical engine system in Embodiment 1 of the present application;

FIG. 8 is a green light MTF graph of the optical engine system in Embodiment 2 of the present application;

FIG. 9 is a red light MTF graph of the optical engine system in Embodiment 2 of the present application;

FIG. 10 is a blue light MTF graph of the optical engine system in Embodiment 2 of the present application;

FIG. 11 is a lateral chromatic aberration graph of the optical engine system in Embodiment 2 of the present application;

FIG. 12 is a schematic diagram of an optical engine system in a comparative example (wherein the illumination assembly is not shown); and

FIG. 13 is a lateral chromatic aberration graph of the optical engine system in the comparative example.

Reference Signs: 1 illumination assembly; 11 light source; 12 collimating lens; 13 microlens array; 14 folding prism; 141 incident surface; 142 reflective surface; 143 exit surface; 15 second polarizer; 2 display chip; 3 relay imaging assembly; 31 polarizing beam splitter; 32 reflective element; 33 first correction lens group; 331 fourth lens; 332 fifth lens; 34 second correction lens group; 341 first lens; 342 second lens; 35 first polarizer; 36 quarter-wave plate; 37 polarizing beam-splitter film.

### DETAILED DESCRIPTION OF THE EMBODIMENTS

The present application will be further described below with reference to specific embodiments. It should be noted that, without conflict, the embodiments or technical features described below can be arbitrarily combined to form new embodiments.

In the description of the present application, it is to be noted that directional terms such as “center,” “transverse,” “longitudinal,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” and the like, which indicate orientation and positional relationships, are based on the orientation or positional relationships illustrated in the drawings. These terms are used merely for the convenience of describing the present application and for simplifying the description, and do not indicate or imply that the apparatus or element referred to must have a particular orientation or be constructed and operated in a particular orientation, and therefore cannot be construed as a limitation on the specific protection scope of the present application.

It should be noted that the terms “first”, “second”, etc., in the specification and claims of the present application are used to distinguish between similar objects, and are not necessarily used to describe a specific order or sequence.

The terms “comprising” and “having” and any of their variations in the specification and claims of the present application are intended to cover a non-exclusive inclusion, for example, a process, method, system, product, or device that comprises a series of steps or units is not necessarily limited to those clearly listed steps or units, but may comprise other steps or units not clearly listed or inherent to such processes, methods, products, or devices.

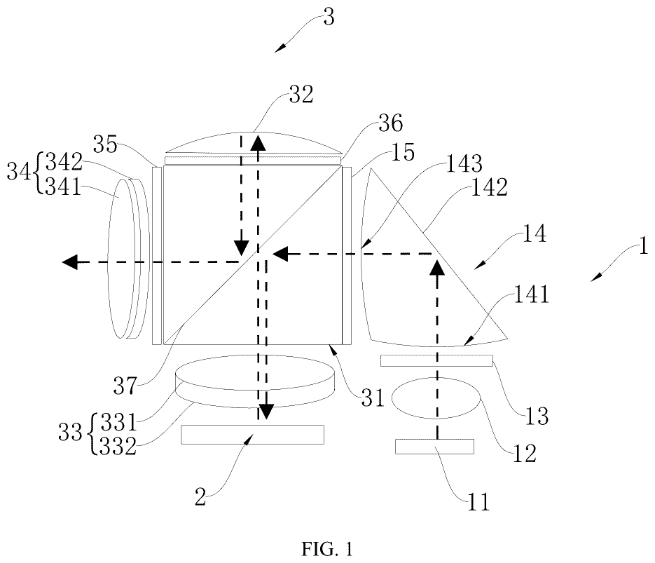

As shown in FIG. 1, the optical engine system of the present application comprises an illumination assembly 1, a display chip 2, and a relay imaging assembly 3. The illumination assembly 1 comprises a light source 11 and a folding prism 14. The light source 11 is configured to provide illumination light, and the folding prism 14 is configured to deflect the illumination light. The display chip 2 is configured to modulate the illumination light into image light. The relay imaging assembly 3 is correspondingly disposed in the optical path between the illumination assembly 1 and the display chip 2, and is configured to transmit the illumination light provided via the illumination assembly 1 to the display chip 2, and to perform imaging projection of the image light modulated by the display chip 2.

As shown in FIG. 1, the relay imaging assembly 3 comprises a polarizing beam splitter 31 and a reflective element 32. The display chip 2 and the reflective element 32 are disposed on opposite sides of the polarizing beam splitter 31, and the display chip 2 and the folding prism 14 are disposed on adjacent sides of the polarizing beam splitter 31. The folding prism 14 has an incident surface 141, a reflective surface 142, and an exit surface 143. The incident surface 141 faces the light source 11, and the exit surface 143 faces the light-incident side of the polarizing beam splitter 31. The light source 11 emits illumination light. The illumination light is deflected by the folding prism 14 and then becomes incident on the polarizing beam splitter 31. After being reflected by the polarizing beam splitter 31, the light reaches the display chip 2. The illumination light is modulated by the display chip 2 and converted into image light. The image light is reflected back, passes through the polarizing beam splitter 31, and reaches the reflective element 32. The image light, after being reflected by reflective element 32, re-enters the polarizing beam splitter 31 and exits through the light-exit side thereof.

It is worth mentioning that the reflective element 32 has positive optical power, and the focal length f₃ of the reflective element 32 and the focal length f of the optical engine system satisfy: 0.6<f/f₃<1. From the relationship between f₃ and f, it can be seen that the reflective element 32 is configured to bear the main optical power of the optical engine system, achieving the short focal length required for a large angle and ensuring that a large field of view can be provided. However, typically, when the FOV (field of view) is large, the chromatic aberration of a full-color projection lens assembly increases sharply. Based on this, the relay imaging assembly 3 of the present application further comprises a first correction lens group 33, configured to correct system chromatic aberration and other residual aberrations.

In some embodiments, the first correction lens group 33 is disposed between the display chip 2 and the polarizing beam splitter 31. The first correction lens group 33 comprises a fourth lens 331 with positive optical power and a fifth lens 332 with negative optical power. The fourth lens 331 and the fifth lens 332 can be cemented. The fourth lens 331 with positive optical power usually produces negative chromatic aberration, and the fifth lens 332 with negative optical power usually produces positive chromatic aberration. By optimizing the ratio of the optical powers of the fourth lens 331 and the fifth lens 332, the negative chromatic aberration of the positive lens and the positive chromatic aberration of the negative lens can cancel each other out, thereby significantly reducing chromatic aberration. In addition, by adjusting the shapes and positions of the fourth lens 331 and the fifth lens 332, the aberrations of the optical engine system can also be effectively corrected.

Furthermore, the fourth lens 331 is disposed on a side close to the polarizing beam splitter 31, and the fifth lens 332 is disposed on a side close to the display chip 2. The illumination assembly 1 emits illumination light. Before the illumination light reaches the display chip 2 after being reflected by the polarizing beam splitter 31, it is first converged and diverged by the fourth lens 331 and the fifth lens 332, and the illumination light is corrected for chromatic aberration and aberrations, so as to better meet the imaging requirements of the display chip 2, thereby presenting a higher quality image with more saturated colors and higher contrast on the display screen.

In some embodiments, the refractive index of the fourth lens 331 is less than that of the fifth lens 332, and the Abbe number of the fourth lens 331 is greater than that of the fifth lens 332. In the combination of the fourth lens 331 and the fifth lens 332, since the refractive index of the fourth lens 331 is lower, light will undergo more significant refraction when entering the fifth lens 332 with a high refractive index, thereby changing the propagation direction of the light, so that the light is focused on the display chip 2 to form a clearer and more uniform image light. The fourth lens 331 uses a high Abbe number material, which can significantly reduce chromatic aberration, allowing light of different wavelengths to focus more closely to the same point. The low Abbe number of the fifth lens 332 can be used to further adjust the focusing characteristics of the light. Through this combination of high and low Abbe numbers, chromatic aberration in the optical system can be effectively corrected.

Furthermore, both surfaces of the fourth lens 331 with positive optical power are convex surfaces, which helps to converge light rays, so that the light rays are fully converged onto the fifth lens 332. For the fifth lens 332 with negative optical power, the surface away from the display chip 2 is a concave surface, and the surface close to the display chip 2 is a convex surface. The combination of the concave and convex surfaces of the fifth lens 332 helps to optimize the distribution range of light on the display chip 2, thereby enhancing the light-utilization efficiency of the display chip 2 with respect to the light from the fourth lens 331 and the fifth lens 332. Furthermore, the surface of the fourth lens 331 close to the polarizing beam splitter 31 is an aspheric surface, which can converge light rays to a more precise focal point, reduce blur, and improve the clarity and sharpness of the image.

Still further, the relay imaging assembly 3 of the present application further comprises a second correction lens group 34 disposed on the light-exit side of the polarizing beam splitter 31, to further reduce the chromatic aberration and residual aberrations in the system. It is worth mentioning that the light-exit side of the polarizing beam splitter 31 is disposed opposite to the light-incident side. In the present application, the first correction lens group 33 is disposed at the position where the image light has just exited from the display chip 2, and the second correction lens group 34 is disposed at the final exit position of the image light. By disposing correction lens groups at these two positions, the chromatic aberration and aberrations of the full-color optical engine system can be reduced more efficiently.

Specifically, after the display chip 2 modulates the incident illumination light into image light, the light first passes through the first correction lens group 33 for chromatic aberration correction, then passes through the polarizing beam splitter 31 to reach the reflective element 32. Subsequently, after the direction of the image light is changed by the reflective element 32, it reaches the polarizing beam splitter 31 again. After being reflected by the polarizing beam splitter 31, it enters the second correction lens group 34 for another chromatic aberration correction, and the corrected image light exits from the exit end.

Furthermore, the second correction lens group 34 comprises a first lens 341 with positive optical power and a second lens 342 with negative optical power. By optimizing the ratio of the optical powers of the first lens 341 and the second lens 342, spherical aberration and coma can be effectively corrected. The first lens 341 is disposed on a side away from the polarizing beam splitter 31, and the second lens 342 is disposed on a side close to the polarizing beam splitter 31. When image light passes through the second correction lens group 34, chromatic aberration and aberrations can be effectively removed, and the image quality can be optimized.

In some embodiments, the refractive index of the first lens 341 is less than the refractive index of the second lens 342, and the Abbe number of the first lens 341 is less than the Abbe number of the second lens 342. The first lens 341 with a lower refractive index usually has a weaker light focusing capability, while the second lens 342 with a higher refractive index has a stronger focusing capability. By reasonably matching the first lens 341 and the second lens 342, better light control can be achieved at different wavelengths, optimizing the overall optical performance of the system. The combination of the first lens 341 with a low Abbe number and the second lens 342 with a high Abbe number can effectively correct chromatic aberration, reduce color halos or blurring, and significantly improve the imaging quality of the optical system.

Furthermore, both surfaces of the first lens 341 with positive optical power are convex surfaces, and for the second lens 342 with negative optical power, the surface close to the exit end of the optical engine system is a concave surface, and the surface away from the exit end of the optical engine system is a planar surface. The diverging effect of the second lens 342 with negative optical power can cooperate with the converging effect of the first lens 341 with positive optical power to jointly correct aberrations in the optical system, such as spherical aberration and chromatic aberration. The image light reflected by the reflective element 32 onto the polarizing beam splitter 31 is reflected by the polarizing beam splitter 31 and enters the combined lens of the first lens 341 and the second lens 342. The planar surface of the second lens 342 with negative optical power away from the exit end can transmit the image light in a stable direction to the concave surface close to the exit end. After the image light is uniformly dispersed by the concave surface, it enters the first lens 341 having a positive optical power and having convex surfaces on both sides for convergence. Finally, image light with uniform brightness and high clarity is output from the exit end.

The first correction lens group 33 and the second correction lens group 34 are mainly used to correct chromatic aberration and other optical aberrations. The two lenses in the first correction lens group 33 are very close to the image plane and function as a field lens, and do not make a major contribution to the optical power. The combined optical power of the two lenses in the second correction lens group 34 is very small, and their contribution to the system's optical power is minimal. Therefore, the optical power of the optical engine system is mainly borne by the reflective element 32.

In some embodiments, the first correction lens group 33 is formed by cementing the fourth lens 331 and the fifth lens 332 to form a doublet lens. By optimizing the radii of curvature and shapes of the fourth lens 331 and the fifth lens 332, light rays can be focused more uniformly when passing through the lens, thereby reducing coma. By adjusting the thicknesses and relative positions of the fourth lens 331 and the fifth lens 332, the doublet lens can change the optical path of light rays passing through the lens, thereby correcting aberrations.

The optical engine system of the present application reuses the fourth lens 331 and the fifth lens 332 from the imaging lens assembly, reducing the required number of relay lenses and effectively reducing the volume and system complexity of the illumination assembly 1.

In some embodiments, the cementing material may be selected from photosensitive adhesive, UV-curable adhesive, optical epoxy resin adhesive, and the like.

Similarly, the second correction lens group 34 is formed by cementing the first lens 341 and the second lens 342 to form a doublet lens.

Furthermore, the relay imaging assembly 3 further comprises a first polarizer 35 and a quarter-wave plate 36. The first polarizer 35 is disposed on the light-exit side of the polarizing beam splitter 31 and located between the second lens 342 and the polarizing beam splitter 31, and can selectively pass light of a specific polarization direction, reducing the interference of stray light and reflected light, and protecting subsequent optical elements. The quarter-wave plate 36 is disposed between the reflective element 32 and the polarizing beam splitter 31 and is cemented to the reflective element 32, and can cause incident light to have a quarter-wavelength phase retardation in a specific direction, converting linearly polarized light into circularly polarized light, or converting circularly polarized light into linearly polarized light.

In some embodiments, the first polarizer 35 is an absorptive linear polarizer, disposed in the optical path between the second lens 342 and the polarizing beam splitter 31, and is attached to the polarizing beam splitter 31, configured to absorb exiting stray light and improve the contrast of the optical engine.

Furthermore, the illumination assembly 1 further comprises a second polarizer 15. The second polarizer 15 is disposed between the exit surface 143 of the folding prism 14 and the polarizing beam splitter 31, ensuring that the light exiting from the exit surface 143 of the folding prism 14 has a uniform polarization direction, providing consistent polarized light for the polarizing beam splitter 31.

In some embodiments, the second polarizer 15 is an absorptive polarizer, disposed in the optical path between the folding prism 14 and the polarizing beam splitter 31, and is attached to the polarizing beam splitter 31, to better control the polarization state of the light, thereby optimizing the performance of the entire system.

The illumination light passes through the second polarizer 15 and becomes first polarized light (e.g., s-polarized light). The first polarized light is reflected by the polarizing beam splitter 31 and enters the first correction lens group 33. After exiting from the first correction lens group 33, it enters the display chip 2. After being modulated by the display chip 2, it forms second polarized light (e.g., p-polarized light). Subsequently, the second polarized light passes through the first correction lens group 33 and the polarizing beam splitter 31 again to reach the quarter-wave plate 36. After being adjusted by the quarter-wave plate 36, it is converted into third polarized light (e.g., circularly polarized light). The third polarized light is reflected by the reflective element 32 and passes through the quarter-wave plate 36 again to be converted into fourth polarized light (e.g., s-polarized light). Subsequently, the fourth polarized light is reflected by the polarizing beam splitter 31 again and exited from the light-exit side, thereafter it enters the second correction lens group 34, which reduceschromatic aberration, then an image is output.

Furthermore, the illumination assembly 1 further comprises a collimating lens 12 and a microlens array 13 sequentially disposed on the light-incident side of the polarizing beam splitter 31. The light source 11 is configured to emit light rays. The collimating lens 12 is configured to collimate the light rays emitted by the light source 11. The microlens array 13 is configured to homogenize the collimated light. The folding prism 14 can be used to reflect the homogenized light to deflect it by 90 degrees before it enters the polarizing beam splitter 31.

Furthermore, the light source 11 can be a three-in-one tri-color LED. The single-path illumination design allows the light source 11 to occupy less space in the illumination assembly 1, which can reduce the size of the optical engine. Furthermore, the doublet lens composed of the fourth lens 331 and the fifth lens 332 in the imaging lens assembly can be reused in the optical engine system, which can better reduce the size of the optical engine. In this way, by using the combined design of the illumination assembly 1, the relay imaging assembly 3, the display chip 2, etc., the miniaturization of the optical engine size can be achieved while ensuring the illumination uniformity of the optical engine system.

Furthermore, both surfaces of the collimating lens 12 are aspheric surfaces. The aspheric collimating lens 12 can minimize aberrations by adjusting the conic constant and aspheric coefficients, so that light rays can be more accurately focused to the same point, improving the collimation of the light rays, thereby improving imaging quality.

Furthermore, the incident surface 141 and the exit surface 143 of the folding prism 14 are aspheric surfaces, configured to converge light rays, and the reflective surface 142 is a planar surface, coated with a high-reflection film. The exit surface 143 faces the polarizing beam splitter 31. Illumination light enters the folding prism 14, is converged by the incident surface 141 to reach the reflective surface 142, is reflected by the reflective surface 142, and is then converged by the exit surface 143 to propagate to the polarizing beam splitter 31. The folding prism 14 can narrow a divergence angle of a light beam and deflect the light propagation direction by 90°, which can effectively reduce the volume of the illumination assembly 1, thereby reducing the volume of the optical engine system.

In some embodiments, the microlens array 13 is preferably a fly's eye microlens array. After the illumination beam is incident on the microlens array 13, more sub-light sources can be formed. Then, after being converged by the folding prism 14, the light homogenization effect of the optical engine system can be further improved. In addition, compared to traditional fly's eye lens arrays, the fly's eye microlens array of the present application can weaken the array image at the projection imaging coupling-out port, improve the screen-door effect that occurs when used with a waveguide device, and help to improve the near-eye display effect.

In some embodiments, the surface of the reflective element 32 away from the polarizing beam splitter 31 is an aspheric surface. The radius of curvature of the surface of the aspheric reflective element 32 varies with the central axis, which can effectively eliminate aberrations inherent in spherical mirrors, such as spherical aberration, coma, and astigmatism. The surface of the reflective element 32 close to the polarizing beam splitter 31 is a planar surface, which can simplify the alignment and assembly process of the optical system, while reducing additional aberrations caused by curved surfaces.

In some embodiments, a reflective film layer is coated on the inner side of the aspheric surface of the reflective element 32 away from the polarizing beam splitter 31 to form a mirror, which can significantly improve reflectivity, reduce light loss, and ensure that more light is reflected and utilized. In some embodiments, the material of the reflective film layer coated on the aspheric surface may be selected from aluminum, nickel-cobalt alloy, etc.

In some embodiments, the reflective element 32 is a plano-convex lens, which can focus incident light rays to a point, achieving an efficient focusing effect. The convex surface of the reflective element 32 has a high-reflection film, which is suitable for acting as a mirror to bear the main optical power of the optical engine system, and can significantly reduce the loss of light during the reflection process, improving the luminous flux and efficiency of the system.

In some embodiments, the quarter-wave plate 36 may be made of, but not limited to, PC (polycarbonate), COP (cyclo olefin polymer), or liquid crystal material. The reverse-dispersion quarter-wave plate 36, by means of a special material and process design, is capable of maintaining a stable phase retardation over a broad wavelength range. This, in turn, improves the performance and stability of the optical system.

In some embodiments, an absorptive second polarizer 15 is attached to the surface of the light-incident side of the polarizing beam splitter 31. The second polarizer 15 acts as an initial polarizer, causing the incident light to change into linearly polarized light.

In some embodiments, the polarizing beam splitter 31 is formed by cementing two right-angle prisms, and is used for polarizing beam splitting. A polarizing beam-splitter film 37 is coated on the cemented surface formed by the two cemented right-angle prisms. The polarizing beam-splitter film 37 is a special optical thin film whose main function is to split incident unpolarized light into two beams of light with different polarization directions, namely P-polarized light (electric field parallel to the incident surface 141) and S-polarized light (electric field perpendicular to the incident surface 141). By separating the polarized light, the influence of stray light on imaging can be effectively reduced, thereby improving the contrast and clarity of the optical system. It is worth mentioning that the polarizing beam-splitter film 37 comprises, but is not limited to, a Wire-Grid PBS (wire-grid polarizing beam splitter) or a Cartesian PBS (Cartesian Polarizing Beam Splitter), which can provide a high extinction ratio and high contrast, and is suitable for applications with extremely high requirements for optical performance.

In some embodiments, the fourth lens 331 and the fifth lens 332 can be edge-trimmed. After edge trimming, the fourth lens 331 and the fifth lens 332 each present a surface profile and dimensions substantially identical to those of the surface of the polarizing beam splitter 31 that faces the display chip 2, so that the overall volume of the optical engine system is further reduced, and the size of the optical engine is miniaturized.

In some embodiments, the side of the reflective element 32 close to the polarizing beam splitter 31 is a planar surface, and the side away from the polarizing beam splitter 31 is a convex surface. A square screen print is provided on the planar side of the reflective element 32, so that the reflective element 32 functions as a vignetting stop to block stray light.

In some embodiments, a compensation plate is disposed between the polarizing beam splitter 31 and the display chip 2. The compensation plate is disposed in the optical path between the fourth lens 331 and the polarizing beam splitter 31, or disposed in the optical path between the fifth lens 332 and the display chip 2, which can effectively compensate for phase differences, optimize the utilization efficiency of polarized light, further effectively improve display visibility, and reduce problems such as color cast and insufficient contrast.

Furthermore, the relay imaging assembly 3 further comprises a first diffuser. The first diffuser is disposed between the exit surface 143 of the folding prism 14 and the second polarizer 15. The first diffuser is adapted to homogenize the intensity distribution of the incident light and reduce light non-uniformity.

In some embodiments, the first diffuser is attached to the second polarizer 15, that is, the first diffuser is on the side close to the folding prism 14, and the second polarizer 15 is on the side close to the polarizing beam splitter 31. In addition, the first diffuser and the second polarizer 15 can also be replaced by a composite film to improve the array image.

Under normal circumstances, the exit pupil of the projection lens assembly, i.e., the position of the aperture stop, is conjugate to the light-exit surface of the fly's eye. That is, the illumination image on the light-exit surface of the fly's eye will be imaged at the exit pupil position of the projection lens assembly, which causes an array image to be formed at the exit pupil position of the projection lens assembly, thereby affecting the waveguide imaging effect. To improve this problem, a diffuser can be added at any position between the fly's eye and the polarizing beam splitter 31. The diffuser can cause the light passing through it to scatter, causing the imaging quality of the optical path that forms the array image to drop sharply. The fly's eye array image projected onto the exit pupil position of the lens assembly becomes blurred, improving the image uniformity at the exit pupil position of the projection lens assembly. Furthermore, the farther the diffuser is from the fly's eye, the better the homogenization effect. In order to achieve the best homogenization effect, the first diffuser is preferably arranged on the side of the second polarizer 15 close to the folding prism 14.

The respective aspheric curve equations for the first lens 341, the second lens 342, the reflective element 32, the fourth lens 331, and the fifth lens 332 of the present application are expressed as follows:

$$X ( Y ) = ( {Y}^{2} / R ) / ( 1 + sqrt ( 1 - ( 1 + k ) \times {( Y / R )}^{2} ) ) + {\sum }_{i} ( {A}_{i} ) \times ( {Y}^{i} )$$

Wherein, X(Y): represents the longitudinal coordinate of a point on the aspheric surface (usually in the direction of the optical axis), and is a function of the transverse coordinate Y. Y: represents the transverse coordinate of a point on the aspheric surface (usually in a direction perpendicular to the optical axis). R: represents the radius of curvature of the aspheric curve at the vertex. The larger the radius of curvature, the flatter the surface; the smaller the radius of curvature, the more curved the surface. k: represents the conic constant, used to describe the shape of the aspheric surface. Different k values correspond to different surface types: k=0: sphere; k>−1: ellipsoid; k=−1: paraboloid; k<−1: hyperboloid. sqrt: represents the square root function. Ai: represents the aspheric coefficient, used to describe the degree of deviation of the aspheric curve from the reference spherical curve. Yi: represents the i-th power of the transverse coordinate Y, used to describe the higher-order terms of the aspheric curve. Σi(Ai)×(Yi): represents the sum of the higher-order terms of the aspheric curve, used to describe the shape of the aspheric surface more accurately. This equation is used to describe the surface shape of an aspheric lens. By adjusting parameters such as R, k, and Ai, the optical performance of the lens can be optimized, aberrations can be reduced, and imaging quality can be improved.

The following are specific embodiments of the optical engine system of the present application:

### Embodiment 1

As shown in FIG. 1, the optical engine system comprises an illumination assembly 1, a display chip 2, and a relay imaging assembly 3. The FOV (field of view) of the optical engine system is 58±1°, and the F # (F-number or aperture number) is 1.77.

The display chip 2 is an LCOS chip of a non-emissive display panel, with a size of 0.24 inch.

The illumination assembly 1 comprises a light source 11 (an RGB three-in-one LED light source), a collimating lens 12 (an aspheric collimating lens), a microlens array 13, a folding prism 14, and a second polarizer 15. The LED light source is a three-in-one type, integrating red, green, and blue, with a light-emitting area of less than 1.1×1.1 mm. The RGB (three primary colors of light) are on a single lamp and are lit up in rotation, respectively. The collimating lens 12 is a convex lens, and both surfaces are aspheric. The microlens array 13 is a fly's eye microlens array, 13×13, and a single fly's eye unit has a length and width of 0.3 mm. The folding prism 14 has an incident surface 141, a reflective surface 142, and an exit surface 143, wherein the incident surface 141 and the exit surface 143 are aspheric and are used to converge light rays. The reflective surface 142 is a planar surface, coated with a high-reflection film. The folding prism 14 can narrow the divergence angle of the light beam and deflect the light propagation direction by 90°, which can effectively reduce the volume of the illumination system. The second polarizer 15 acts as an initial polarizer, causing the incident light to change into linearly polarized light.

The relay imaging assembly 3 comprises a polarizing beam splitter 31, a reflective element 32, a fourth lens 331, a fifth lens 332, a first lens 341, a second lens 342, a first polarizer 35, a quarter-wave plate 36, and a polarizing beam-splitter film 37. In FIG. 1, the first lens 341 is a positive lens; the second lens 342 is a negative lens, its surface close to the exit end is a concave surface, and its surface away from the exit end is a planar surface; the first polarizer 35 is an absorptive linear polarizer, cemented between the second lens 342 and the polarizing beam splitter 31; the polarizing beam splitter 31 is formed by cementing two right-angle prisms; the reflective element 32 is a plano-convex lens, and the convex surface is coated with a high-reflection film. The quarter-wave plate 36 is cemented between the reflective element 32 and the polarizing beam splitter 31. The fourth lens 331 and the fifth lens 332 form a doublet lens, which is used to correct chromatic aberration. Wherein the fourth lens 331 is a positive lens, the surface close to the polarizing beam splitter 31 is aspheric, with a low refractive index and a high Abbe number; the fifth lens 332 is a negative lens, with a high refractive index and a low Abbe number.

Table 1 shows the specific parameters of each lens in the relay imaging assembly 3. In Table 1, surface 1 of the first lens 341 is a convex surface on the side away from the polarizing beam splitter 31, and surface 2 is a convex surface on the side close to the polarizing beam splitter 31; surface 3 of the second lens 342 is a concave surface on the side close to the exit end, and surface 4 is a planar surface on the side away from the exit end; surface 5 of the polarizing beam splitter 31 is an inclined surface on the side close to the reflective element 32, and surface 6 is an inclined surface on the side close to the display chip 2; surface 7 of the reflective element 32 is an aspheric surface on the side away from the polarizing beam splitter 31, and surface 8 is a planar surface on the side close to the polarizing beam splitter 31; surface 9 of the fourth lens 331 is a convex surface on the side away from the display chip 2, and surface 10 is a convex surface on the side close to the display chip 2; surface 11 of the fifth lens 332 is a concave surface on the side away from the display chip 2, and surface 12 is a convex surface on the side close to the display chip 2.

TABLE 1
Table 1 Optical parameters of lenses (all lenses are made of glass material)

| | | Radius of | | Refractive | Abbe | Focal |
|---|---|---|---|---|---|---|
| Lens | Surface | Curvature | Thickness | Index | Number | Length |
| First lens 341 | Surface 1 | 22.20 | 0.45 | 1.805 | 25 | 19.9 |
| | Surface 2 | −57.5 | | | | |
| Second lens 342 | Surface 3 | −20.59 | 0.3 | 1.850 | 32 | −24.2 |
| | Surface 4 | ∞ | | | | |
| Polarizing beam | Surface 5 | ∞ | 5.23 | 1.569 | 71 | ∞ |
| splitter 31 | Surface 6 | ∞ | | | | |
| Reflective | Surface 7 | 21.6 | 0.49 | 1.496 | 81 | 7.21 |
| element 32 | Surface 8 | ∞ | | | | |
| Fourth lens 331 | Surface 9 | 12.6 | 1.85 | 1.693 | 53 | 7.03 |
| | Surface 10 | −7.48 | | | | |
| Fifth lens 332 | Surface 11 | −7.48 | 1.11 | 1.946 | 18 | −16.49 |
| | Surface 12 | −15.24 | | | | |

As shown in Table 2 below, the aspheric coefficients of the aspheric curve equations for Surface 7 and Surface 9 are specifically displayed, wherein K represents the conic coefficient, used to describe the basic deviation of the optical surface relative to an ideal spherical surface; A4, A6, A8, A10, A12 represent the higher-order aspheric coefficients, used to describe the complex shape deviations of the optical surface.

TABLE 2
Table 2 Aspheric coefficients

| Surface | Surface 7 | Surface 9 |
|---|---|---|
| K | 13.09 | 9.75 |
| A4 | −0.0002 | −0.0007 |
| A6 | 2.500E−06 | −2.814E−06 |
| A8 | −1.303E−06 | −7.946E−06 |
| A10 | 1.324E−07 | 8.791E−07 |
| A12 | −5.353E−09 | −4.640E−08 |

The focal length f of the lens assembly of the optical engine system in this embodiment is 6.08 mm, and the ratio of the focal length f of the lens assembly to the focal length f₃ of the reflective element 32 is 0.6<f/f₃<1; the combined focal length of the first lens 341 and the second lens 342 is 106.2 mm, its combined optical power is very small, and its contribution to the optical power of the optical engine system is very small; the combined focal length of the fourth lens 331 and the fifth lens 332 is 12.46 mm, the fourth lens 331 and the fifth lens 332 are close to the image plane and mainly act as a field lens, and their contribution to the optical power is small. The optical power of the optical engine system in this embodiment is mainly contributed by the reflective element 32.

The optical path of the optical engine system in this embodiment is as follows: after light is emitted from the light source 11 (LED), it passes through a single-piece collimating lens 12 for beam collimation. The collimated beam passes through the microlens array 13 for light homogenization, then enters the polarizing beam splitter 31 via the folding prism 14, and enters the cemented lens composed of the fourth lens 331 and the fifth lens 332, forming a square uniform illumination pattern that illuminates the display area of the display chip 2 (LCoS). Specifically, after light homogenization, the light enters the folding prism 14, is deflected by 90°, passes through the second polarizer 15 between the folding prism 14 and the polarizing beam splitter 31 and becomes first polarized light (e.g., s-polarized light). The first polarized light enters the polarizing beam splitter 31, is reflected at the beam splitting surface of the polarizing beam splitter 31, passes through the cemented lens composed of the fourth lens 331 and the fifth lens 332, and becomes incident on the LCOS. After being modulated and reflected by the LCOS, the first polarized light is converted into second polarized light (e.g., p-polarized light). The second polarized light enters the polarizing beam splitter 31 again, passes through the beam splitting surface of the polarizing beam splitter 31, then passes through the quarter-wave plate 36 and is converted into third polarized light (e.g., circularly polarized light). The third polarized light is reflected by the reflective element 32, passes through the quarter-wave plate 36 again and is converted into fourth polarized light (e.g., s-polarized light), which enters the polarizing beam splitter 31, is reflected at the beam splitting surface of the polarizing beam splitter 31, and passes through the first lens 341 and the second lens 342 to the exit end.

Table 3 below shows the optical efficiency and intensity uniformity data of this embodiment obtained through non-sequential ray tracing simulation using simulation software (LightTools). These are theoretical values without considering manufacturing tolerances. The table provides a theoretical basis for evaluating the performance of the optical engine system under different colored lights by listing the design values of optical efficiency and intensity uniformity for different color channels.

TABLE 3
Table 3 Performance

| No. | | Color Channel | Design Value |
|---|---|---|---|
| 1 | Optical Engine | White | 17.30% |
| 2 | Efficiency | Red | 16.26% |
| 3 | | Green | 17.19% |
| 4 | | Blue | 17.10% |
| 7 | Intensity | White | 69% |
| 8 | Uniformity | Red | 60% |
| 9 | | Green | 67% |
| 10 | | Blue | 58% |

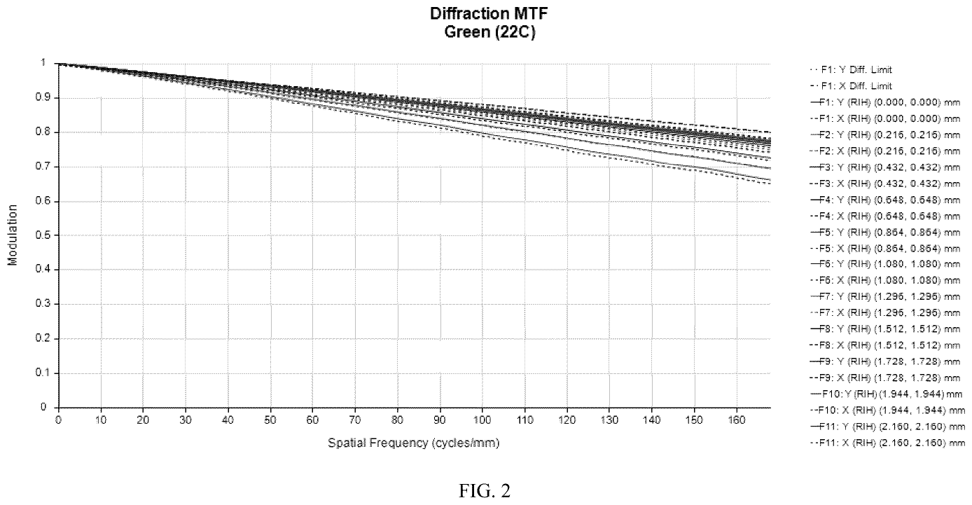

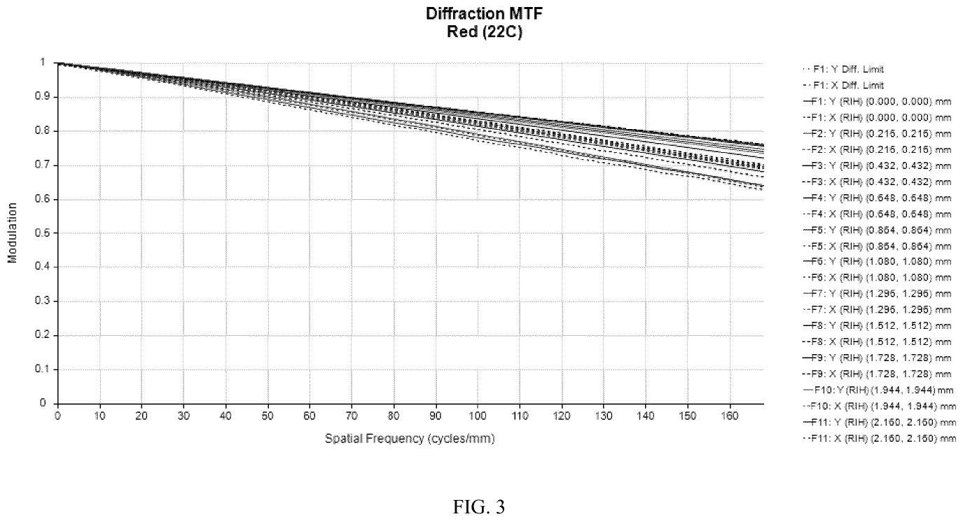

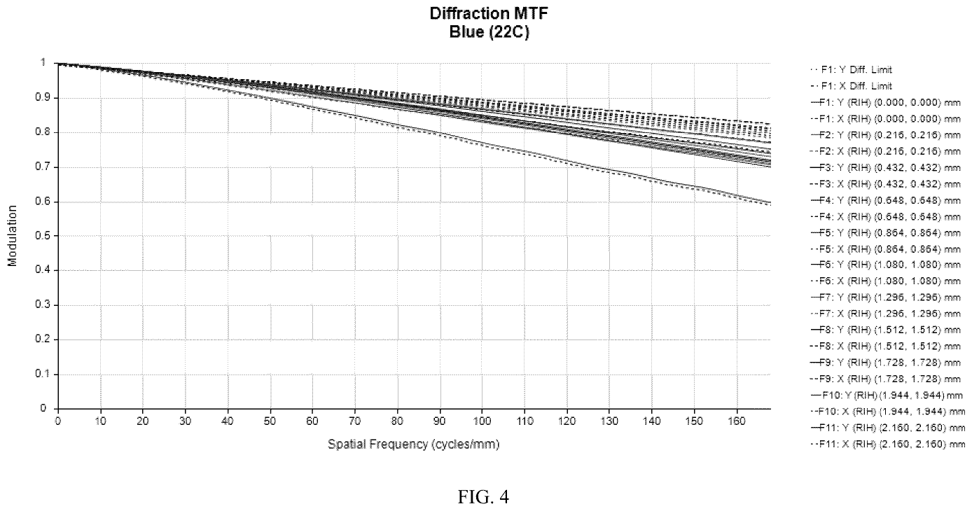

FIGS. 2, 3, and 4 are the MTF graphs for red, green, and blue light of the optical engine system, respectively. The MTF graphs for red, green, and blue light provide information on the imaging quality of the optical system at different wavelengths. The optical engine system of the present application achieves a projection lens assembly design with an FOV of 58°, and at the same time, at 166 lp/mm, the MTF (Modulation Transfer Function) for red, green, and blue light are all greater than 50%. Therefore, the optical engine system according to Embodiment 1 of the present application has a lens assembly with high resolution, which is capable of resolving finer image details, helps to improve imaging quality, resolution, and color performance, and meets the needs of various high-precision imaging applications.

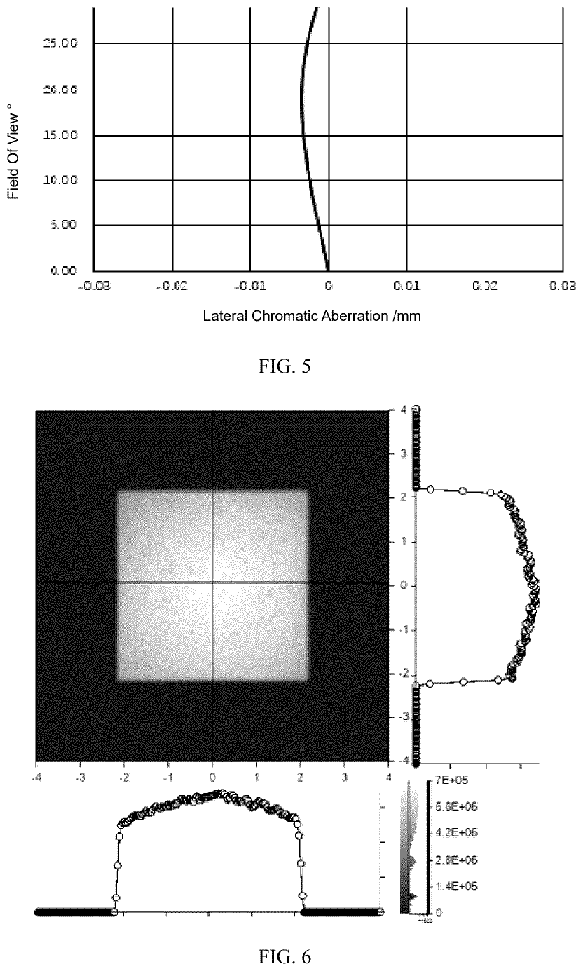

FIG. 5 is a lateral chromatic aberration graph of Embodiment 1, showing the vertical offset on the image plane for light rays of different wavelengths (colors) after passing through the optical system. As the field of view increases, the curve of the lateral chromatic aberration graph approaches 0 mm, and the lateral chromatic aberration is less than 3 μm. This indicates that in Embodiment 1 of the present application, as the field of view of the full-color optical engine system increases, the difference in the focusing positions of light rays of different wavelengths on the image plane gradually decreases, resulting in a good chromatic aberration correction effect and high imaging quality.

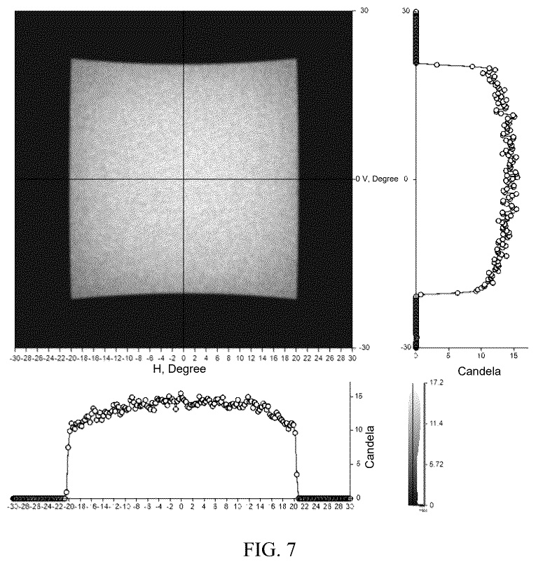

As shown in FIG. 6, which is an LCOS illuminance result graph of the optical engine system, the light intensity values range from 1.4E+05 to 7E+05. The light intensity value gradually decreases from the center to the edge. The highest light intensity in the central area is 7E+05, and the lowest light intensity in the edge area is 1.4E+05. The LCOS central illumination brightness reaches a high level. As shown in FIG. 7, which is an intensity distribution diagram of the projected image of the optical engine system, the brightness uniformity of the projected image is greater than 65%, the overall luminous efficacy is greater than 10 lm/w, and the volume (length×width×height) of the optical engine is less than 1.71 cc, effectively reducing the size of the optical engine system and making it more convenient for integration.

### Embodiment 2

The difference between Embodiment 2 and Embodiment 1 is that:

The first lens 341 is made of plastic material. The optical parameters (radius of curvature, thickness, refractive index, Abbe number, focal length) of each lens are shown in Table 4 below.

TABLE 4
Table 4 Optical parameters of lenses

| | | Radius of | | Refractive | Abbe | Focal |
|---|---|---|---|---|---|---|
| Lens | Surface | Curvature | Thickness | Index | Number | Length |
| First lens 341 | Surface 1 | 46.77 | 0.453 | 1.588 | 18 | 19.7 |
| | Surface 2 | −15.65 | | | | |
| Second lens 342 | Surface 3 | −20.85 | 0.3 | 1.850 | 32 | −24.2 |
| | Surface 4 | ∞ | | | | |
| Polarizing beam | Surface 5 | ∞ | 5.208 | 1.569 | 71 | ∞ |
| splitter 31 | Surface 6 | ∞ | | | | |
| Reflective | Surface 7 | 20.86 | 0.494 | 1.496 | 81.5 | 6.96 |
| element 32 | Surface 8 | ∞ | | | | |
| Fourth lens 331 | Surface 9 | 14.92 | 1.733 | 1.692 | 53 | 36.3 |
| | Surface 10 | −6.37 | | | | |
| Fifth lens 332 | Surface 11 | −6.37 | 1.073 | 1.945 | 18 | −15.2 |
| | Surface 12 | −12.18 | | | | |

As shown in Table 5 below, the aspheric coefficients of the aspheric curve equations for Surface 1, Surface 2, Surface 7, and Surface 9 are specifically displayed, wherein K determines the basic shape of the surface, and the higher-order aspheric coefficients (A4, A6, A8, A10, A12) are used to further optimize the surface shape and correct aberrations.

TABLE 5
Table 5 Aspheric coefficients

| Sur- | | | | |
|---|---|---|---|---|
| face | 1 | 2 | 7 | 9 |
| K | 99 | 51.5083149735716 | 10.674 | 4.909 |
| A4 | −0.0025 | −0.0009 | −0.0001 | −0.0007 |
| A6 | 3.735e−05 | 0.0006 | −2.701E−06 | 1.795E−05 |
| A8 | −6.982e−05 | −0.0002 | 8.204E−09 | −1.267E−05 |
| A10 | | 3.654e−05 | | 2.100E−06 |
| A12 | | | | 4.250E−09 |

The focal length f of the lens assembly of the optical engine system in this embodiment is 5.98 mm, and the ratio of the focal length f of the lens assembly to the focal length f₃ of the reflective element 32 is 0.6<f/f₃<1; the combined focal length of the first lens 341 and the second lens 342 is 103.4 mm, its combined optical power is very small, and its contribution to the optical power of the optical engine system is very small; the combined focal length of the fourth lens 331 and the fifth lens 332 is 12.21 mm, the fourth lens 331 and the fifth lens 332 are close to the image plane and mainly act as a field lens, and their contribution to the optical power is small. The optical power of the optical engine system in this embodiment is mainly contributed by the reflective element 32.

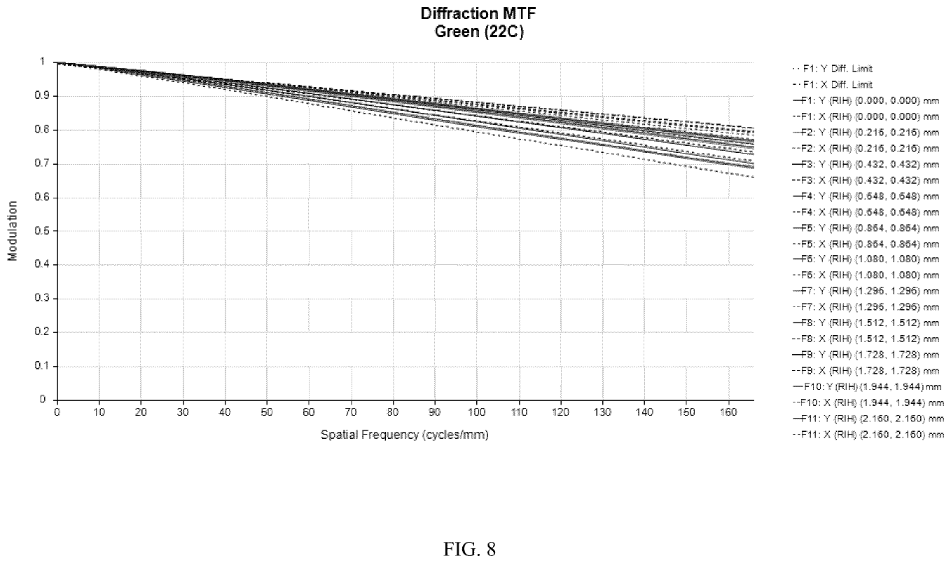

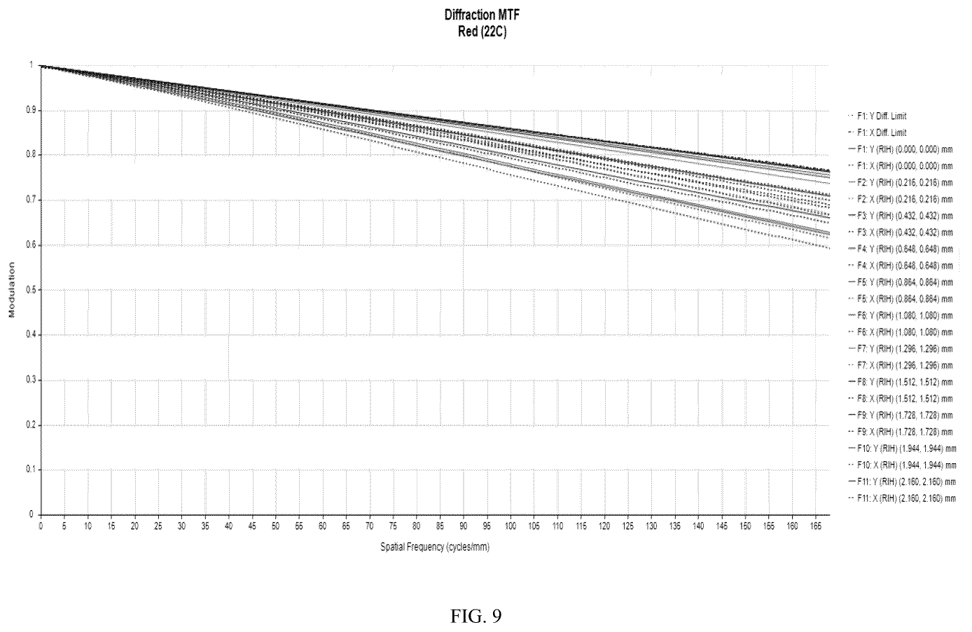

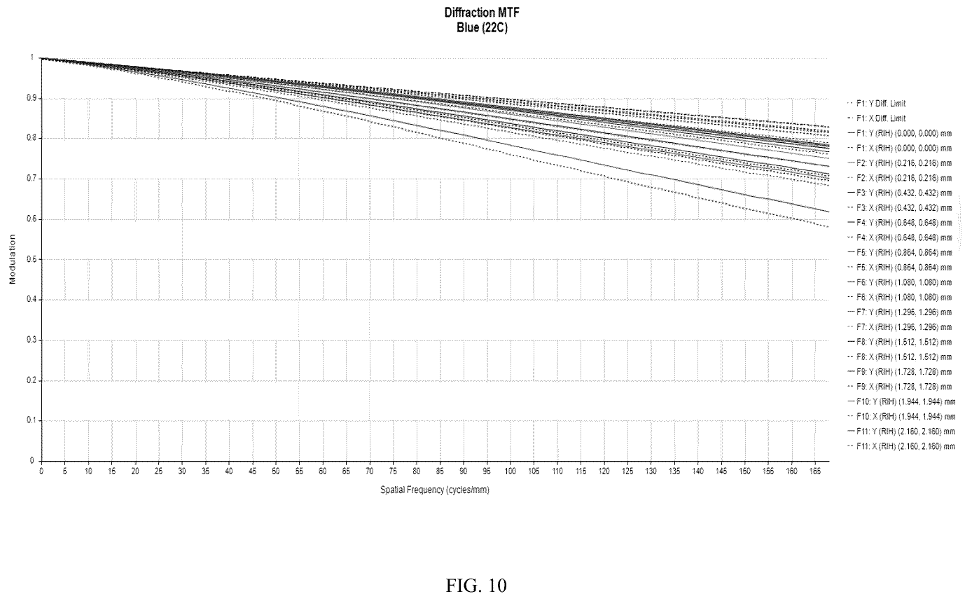

As shown in FIGS. 8, 9, and 10, the optical engine system in this embodiment achieves large-viewing-angle image projection with an FOV greater than 58°, and at the same time, at 166 lp/mm, the MTF (Modulation Transfer Function) for red, green, and blue light are also all greater than 50%. Therefore, the optical engine system according to Embodiment 2 of the present application can also meet the requirement of further increasing the optical engine resolution to 167 lp/mm.

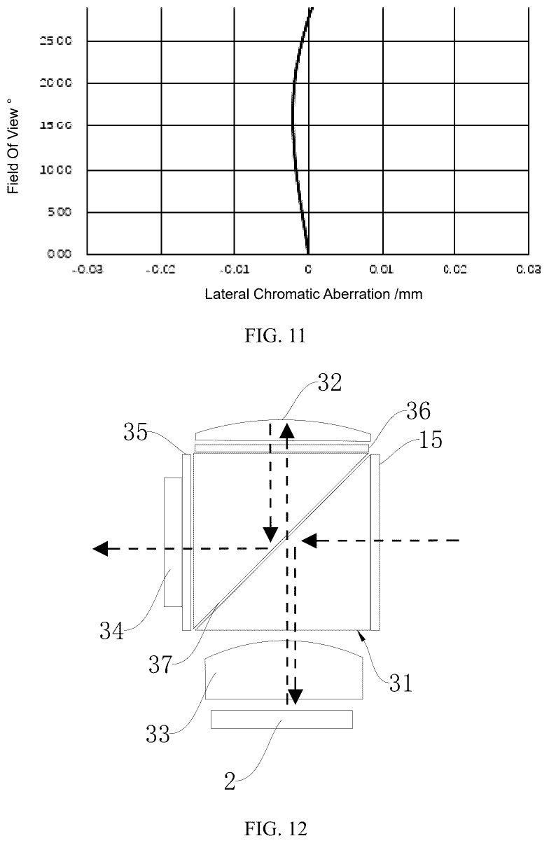

As shown in FIG. 11, as the field of view increases, the curve approaches 0 mm, and the lateral chromatic aberration is less than 3 μm. This indicates that in Embodiment 2 of the present application, as the field of view of the optical engine system increases, the difference in the focusing positions of light rays of different wavelengths on the image plane gradually decreases, resulting in a good chromatic aberration correction effect and high imaging quality.

### Comparative Example 1

The difference between Comparative Example 1 and Embodiment 1 is that:

As shown in FIG. 12, in Comparative Example 1, both the first correction lens group 33 and the second correction lens group 34 are replaced by a single integral lens. Since an integral lens is usually made of a single material, it is not possible to cancel out chromatic aberration through material combination. Therefore, the chromatic aberration of an integral lens is mainly determined by the dispersion characteristics of the material, and thus it is difficult to correct the chromatic aberration through design adjustments.

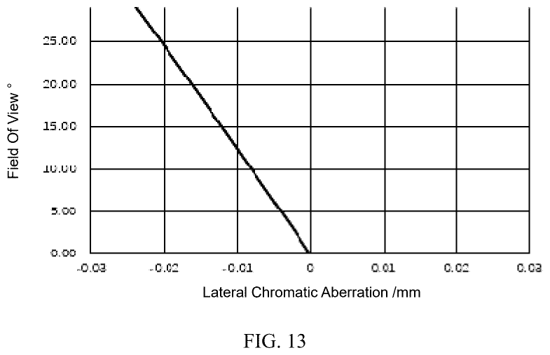

As shown in FIG. 13, for a large field of view) (FOV>50° design specification, the optical engine system in Comparative Example 1, relying only on the reflective element 32, finds it difficult to achieve chromatic aberration correction for the lens assembly. The figure shows that the lateral chromatic aberration of the system without a cemented lens system is greater than 25 μm, which is much larger than the pixel size, and this has a significant impact on the imaging quality of the optical engine system.

The above describes the basic principles, main features, and advantages of the present application. Those skilled in the art should understand that the present application is not limited by the above-mentioned embodiments, and that what is described in the above-mentioned embodiments and the specification are only the principles of the present application. Various changes and modifications can be made to the present application without departing from the spirit and scope of the present application, and these changes and modifications fall within the scope of the present application to be protected. The scope of protection claimed by the present application is defined by the appended claims and their equivalents.

What is claimed is:

1. An optical engine system, comprising:
an illumination assembly, comprising a light source and a folding prism, wherein the light source is configured to provide illumination light, and the folding prism has an incident surface facing the light source, a reflective surface, and an exit surface facing a polarizing beam splitter, and is configured to deflect the illumination light; wherein the incident surface and the exit surface are aspheric surfaces configured to converge light rays, the reflective surface is a planar surface coated with a high-reflection film, and the folding prism is configured to narrow a divergence angle of a light beam;
a display chip, configured to modulate the illumination light into image light;
a relay imaging assembly, comprising the polarizing beam splitter, a first correction lens group, and a reflective element, wherein the display chip and the reflective element are disposed on opposite sides of the polarizing beam splitter, and the display chip and the folding prism are disposed on adjacent sides of the polarizing beam splitter, the first correction lens group is disposed between the polarizing beam splitter and the display chip, the first correction lens group comprises a fourth lens and a fifth lens that are cemented together, the fourth lens with positive optical power is disposed on a side close to the polarizing beam splitter, and the fifth lens with negative optical power is disposed on a side close to the display chip; wherein the reflective element has positive optical power, and the focal length f₃ of the reflective element and the focal length f of the optical engine system satisfy: 0.6<f/f₃<1;
wherein the relay imaging assembly further comprises a second correction lens group disposed on a light-exit side of the polarizing beam splitter, the second correction lens group comprises a first lens with positive optical power and a second lens with negative optical power, the first lens is disposed on a side away from the polarizing beam splitter, and the second lens is disposed on a side close to the polarizing beam splitter.

2. The optical engine system according to claim 1, wherein a surface of the reflective element away from the polarizing beam splitter is an aspheric surface, an inner side of the aspheric surface is coated with a reflective film, and a surface of the reflective element close to the polarizing beam splitter is a planar surface.

3. The optical engine system according to claim 1, wherein a refractive index of the fourth lens is less than a refractive index of the fifth lens, and an Abbe number of the fourth lens is greater than an Abbe number of the fifth lens.

4. The optical engine system according to claim 1, wherein both surfaces of the fourth lens are convex surfaces, a surface of the fifth lens away from the display chip is a concave surface, and a surface close to the display chip is a convex surface.

5. The optical engine system according to claim 1, wherein a refractive index of the first lens is less than a refractive index of the second lens, and an Abbe number of the first lens is less than an Abbe number of the second lens.

6. The optical engine system according to claim 1, wherein both surfaces of the first lens are convex surfaces, a surface of the second lens close to an exit end is a concave surface, and a surface away from the exit end is a planar surface.

7. The optical engine system according to claim 1, wherein the first lens and the second lens are cemented together.

8. The optical engine system according to claim 1, wherein the relay imaging assembly further comprises a first polarizer and a quarter-wave plate, wherein the first polarizer is disposed on the light-exit side of the polarizing beam splitter and between the second lens and the polarizing beam splitter; and the quarter-wave plate is disposed between the reflective element and the polarizing beam splitter.

9. The optical engine system according to claim 1, wherein the illumination assembly further comprises a second polarizer, wherein the second polarizer is disposed between the exit surface of the folding prism and the polarizing beam splitter.

10. The optical engine system according to claim 9, wherein the relay imaging assembly further comprises a first diffuser, wherein the first diffuser is disposed between the exit surface of the folding prism and the second polarizer.

11. A near-eye display device, comprising the optical engine system according claim 1 and a waveguide device, wherein the optical engine system is disposed on an in-coupling side of the waveguide device and is configured to project the image light to an in-coupling port of the waveguide device.
